(19) United States
(12) Patent Application Publication
(10) Pub. No.: US 2006/0265858 A1
(43) Pub. Date: Nov. 30, 2006

(54) Endodontic instrument having notched cutting surfaces

(76) Inventor: John T. McSpadden, Lookout Mountain, GA (US)

Correspondence Address: LUEDEKA, NEELY & GRAHAM, P.C., P O BOX 1871, KNOXVILLE, TN, 37901, US

(21) Appl. No.: 11/402,432

(22) Filed: Apr. 12, 2006

Related U.S. Application Data
(63) Continuation-in-part of application No. 11/130,824, filed on May 17, 2005.
Application No. 11/130,824 is a continuation of application No. 10/219,927, filed on Aug. 15, 2002, now Pat. No. 6,966,774.
(60) Provisional application No. 60/670,547, filed on Apr. 12, 2005.

(51) Int. Cl. B23P 13/04

(52) U.S. Cl. 29/558; 29/557

(57) ABSTRACT

A method and apparatus for fabricating endodontic instruments for cleaning and extirpating a root canal. A grinding assembly may be used to form multiple cutting surfaces in elongate shafts in a single pass. A working surface holding a plurality of shafts may also be used to allow cutting surfaces to be formed in multiple shafts during one pass by the grinding assembly.

### CROSS REFERENCE TO RELATED APPLICATIONS

This application claims priority under 35 U.S.C. §119(e) to provisional application Ser. No. 60/670,547 and is a continuation-in-part of pending U.S. patent application Ser. No. 11/130,824, which is a continuation of U.S. patent application Ser. No. 10/219,927, now U.S. Pat. No. 6,966,774.

### FIELD OF THE INVENTION

The present invention relates generally to the field of dentistry and more particularly to a fluteless endodontic instrument having notched cutting surfaces for cleaning and enlarging a root canal and methods of manufacturing endodontic instruments.

### DESCRIPTION OF THE RELATED ART

In the field of endodontics, one of the most important and delicate procedures is that of cleaning or extirpating a root canal to provide a properly dimensioned cavity while essentially maintaining the central axis of the canal. This step is important in order to enable complete filling of the canal without any voids and in a manner which prevents the entrapment of noxious tissue in the canal as the canal is being filled.

In a root canal procedure, the dentist removes injured tissue and debris from the canal prior to filling the canal with an inert filling material. In performing this procedure the dentist must gain access to the entire canal, shaping it as necessary. But root canals normally are very small in diameter, and they are usually quite curved. It is therefore very difficult to gain access to the full length of a root canal.

Many tools have been designed to perform the difficult task of cleaning and shaping root canals. Historically, dentists have used a wide multitude of tools to remove the soft and hard tissues of the root canal. These tools, usually called endodontic files, have been made by three basic processes. In one process, a file is created by twisting a prismatic rod of either square or triangular cross section in order to create a file with helical cutting/abrading edges (“K-file”). The second process involves grinding helical flutes into a circular or tapered rod to create a file with one or more helical cutting edges (“Hedstrom file”). The third method involves “hacking” or rapidly striking a circular or tapered rod with a blade at a given angle along the length of the rod, thus creating an endodontic file characterized by a plurality of burr-like barbs or cutting edge projections (“barbed file” or “broach”). Each of these methods produces an instrument having unique attributes, advantages, and disadvantages.

Endodontic files have historically been made from stainless steel, but due to the inherent stiffness and brittleness of steel, these tools can sometimes pose a significant danger of breakage in the curved root canal. More recent designs have attempted to overcome these problems. Some attempt to alter the geometry of the stainless steel file in order to provide more flexibility. This approach has had only limited success, and the stainless steel tools still have a tendency to break if over-torqued or fatigued.

A series of comparative tests of endodontic instruments made of nickel-titanium alloy (Nitinol™ or NiTi) and stainless steel were conducted and published in an article entitled “An Initial Investigation of the Bending and the Torsional Properties of Nitinol Root Canal Files,” Journal of Endodontics, Volume 14, No. 7, July 1988, pages 346-351. The Nitinol instruments involved in these tests were manufactured in accordance with fabrication procedures and operating parameters conventionally used in the machining of stainless steel endodontic instruments. This process involved grinding a helical flute in a tapered shaft to form helical cutting edges.

The reported tests demonstrated that the NiTi instruments produced by the described machining process exhibited superior flexibility and torsional properties as compared to stainless steel instruments, but the cutting edges of the instruments exhibited heavily deformed metal deposits which, according to the article, rendered the instruments generally unsatisfactory for clinical use.

In general, alloys of nickel (Ni) and titanium (Ti) have a relatively low modulus of elasticity (0.83 GPa) over a wide range, a relatively high yield strength (0.195-690 MPa), and the unique and the unusual property of being “superelastic” over a limited temperature range. Superelasticity refers to the highly exaggerated elasticity, or spring-back, observed in many NiTi and other superelastic alloys over a limited temperature range. Such alloys can deliver over 15 times the elastic motion of a spring steel, i.e., withstand twisting or bending up to 15 times greater without permanent deformation. The particular physical and other properties of Nitinol alloys may be varied over a wide range by adjusting the precise Ni/Ti ratio used. However, the superelastic properties of NiTi also make the material very difficult and expensive to machine.

Machining of NiTi tools for endodontic use has been an area of significant development efforts in recent years. For example, U.S. Pat. No. 5,464,362 to Heath et. al. describes a method of grinding a rod of a nickel-titanium alloy in order to create a fluted file. However, current state-of-the art manufacturing processes remain relatively expensive and slow and require sophisticated 6-axis grinding machines and the like.

Accordingly, there is a need for an improved endodontic file design which will allow for more economical manufacture of an endodontic tool from nickel titanium and other suitable alloys.

### SUMMARY OF THE INVENTION

It is therefore an object of the present invention to provide an improved endodontic file design and method of manufacturing such files from nickel-titanium alloys, stainless steel and/or other materials.

According to one embodiment of the present invention, a method for fabricating an endodontic instrument for cleaning and extirpating a root canal comprises selecting at least one elongated shaft of material having multiple side surfaces and multiple interposed corners. A grinding wheel is moved across at least one of the corners. In one pass of the grinding wheel across the at least one of the corners, multiple recesses are formed along the at least one of the corners. The recesses define exposed cutting surfaces adapted to contact walls of a root canal when the instrument is rotated and/or reciprocated therein.

According to another embodiment of the present invention, an apparatus for fabricating an endodontic instrument for cleaning and extirpating a root canal comprises a working space for supporting at least one elongated shaft of material having multiple side surfaces and multiple interposed corners. The apparatus also includes a grinding instrument for forming notches on the interposed corners of the shaft. Means are provided for forming multiples recesses on one of the interposed corners of the shaft in a single pass across the interposed corners.

According to another embodiment of the present invention, an apparatus for fabricating an endodontic instrument for cleaning and extirpating a root canal comprises a working space for supporting a plurality of elongated shafts. Each shaft has multiple side surfaces and multiple interposed corners. A grinding instrument is provided for forming notches on the interposed corners of the shafts. Means are provided for forming multiples recesses on one of the interposed corners of the plurality in a single pass across the interposed corners.

Another embodiment of the present invention comprises an apparatus for fabricating an endodontic instrument for cleaning and extirpating a root canal. The apparatus includes a working space for supporting at least one elongated shaft having multiple side surfaces and multiple interposed corners. The apparatus also includes a machining instrument for forming a plurality of notches on at least one interposed corner of the shaft, the machining instrument having a plurality of cutting implements for forming multiples recesses on the at least one interposed corner of the shaft in a single pass across the at least one interposed corner.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and its essential features and advantages, certain preferred embodiments and modifications thereof will become apparent to those skilled in the art from the detailed description herein having reference to the figures that follow, of which:

FIG. 1 is a section view of a tooth and root structure illustrating the use of a conventional fluted endodontic instrument for performing a typical root canal procedure;

FIG. 2A is a side elevation view of a fluteless endodontic instrument;

FIG. 2B is a partial cross-section detail view of the fitting portion of the fluteless endodontic instrument of FIG. 2A;

FIG. 2C is a top plan view of the fitting portion of the fluteless endodontic instrument of FIG. 2A;

FIG. 2D is a detail view of the working portion of the fluteless endodontic instrument of FIG. 2A, illustrating multiple vertically aligned notched cutting surfaces formed thereon;

FIG. 2E is a detail view of the distal portion of the fluteless endodontic instrument of FIG. 2A, illustrating the tip geometry thereof;

FIG. 2F is a bottom plan view of the working portion of the fluteless endodontic instrument of FIG. 2A;

FIG. 2G is a partial cross-section view of the working portion of the fluteless endodontic instrument of FIG. 2A;

FIGS. 3A-H are schematic views of various modified embodiments of a fluteless endodontic instrument;

FIGS. 4A-C are time-sequenced isometric views illustrating one preferred method for manufacturing an endodontic instrument having features and advantages of the present invention; and

FIG. 5 is a top plan view illustrating another preferred method for manufacturing an endodontic instrument having features and advantages of the present invention.

### DETAILED DESCRIPTION OF THE PREFERRED EMBODIMENTS

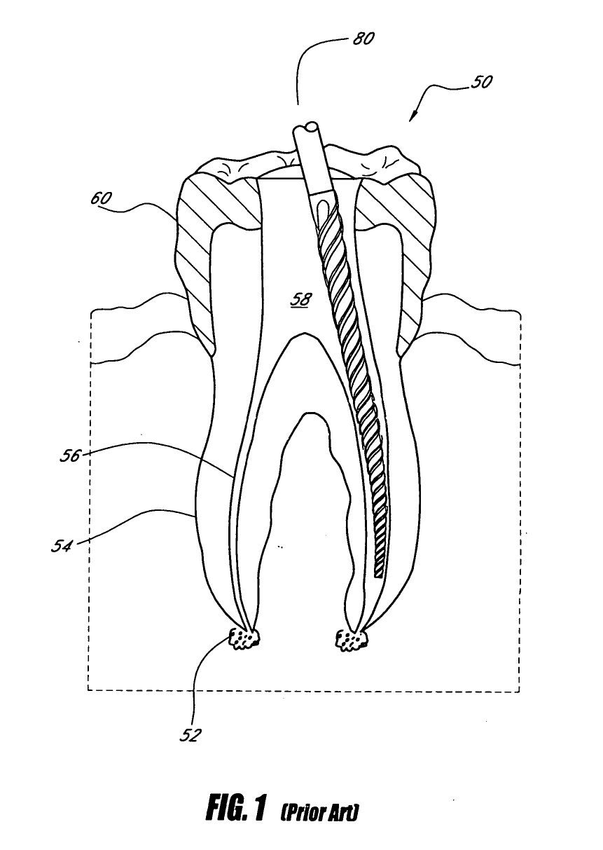

FIG. 1 is a partial cross section of a tooth 50 and supporting root structure illustrating the use of a typical fluted endodontic file 80 to carry out a standard root canal procedure. The root canal 56 of a tooth houses the circulatory and neural systems of the tooth. These enter the tooth at the terminus 52 of each of its roots 54 and extend through a narrow, tapered canal system to a pulp chamber 58 adjacent the crown portion 60 of the tooth. If this pulp tissue becomes diseased or injured, it can cause severe pain and trauma to the tooth, sometimes necessitating extraction of the tooth. Root canal therapy involves removing the diseased tissue from the canal 56 and sealing the canal system in its entirety. If successful, root canal therapy can effectively alleviate the pain and trauma associated with the tooth so that it need not be extracted.

To perform a root canal procedure, the endodontist first drills into the tooth 50 to locate the root canal(s) 56 and then uses an endodontic file or reamer instrument 80 to remove the decayed, injured or dead tissue from the canal. These instruments are typically elongated cutting or abrading instruments which are rotated and/or reciprocated within the root canal either by hand or using a slow speed drill. The primary goal is to remove all of the decayed or injured pulp tissue while leaving the integrity of the central axis of the root canal relatively unaffected. Proper cleaning and shaping of the root canal 56 is important in order to allow complete filling of the root canal void in a homogenous three dimensional manner such that leakage or communication between the root canal system and the surrounding and supporting tissues of the tooth 50 is prevented. Once as much of the diseased material as practicable is removed from the root canal, the canal 56 is sealed closed, typically by reciprocating and/or rotating a condenser instrument in the canal to urge a sealing material such as gutta-percha into the canal.

One of the primary challenges in performing root canal therapy is that the root canals are not necessarily straight and are often curved or convoluted. Therefore, it is often difficult to clean the canal while preserving its natural shape. Many instruments (particularly the older, stainless steel instruments) have a tendency to straighten out the canal or to proceed straight into the root canal wall, altering the natural shape of the canal. In some extreme cases, the instrument may transport completely through the canal wall causing additional trauma to the tooth and/or surrounding tissues. Also, the openings of many root canals are small, particularly in older patients, due to calcified deposits on the root canal inner walls. Thus the files or reamers must be able to withstand the torsional load necessary to penetrate and enlarge the canal opening without breaking the instrument, as may also occasionally occur with the older stainless steel endodontic files.

To alleviate the transportation and breakage problems, highly flexible endodontic files fabricated from nickel-titanium alloy (Nitinol™ or NiTi) were introduced and have become widely accepted. See, e.g. U.S. Pat. No. 5,882,198, incorporated herein by reference. But conventional fluted instrument designs are difficult to manufacture from Nitinol alloys, often requiring expensive grinding operations and specialized 6-axis grinding machines to create the desired continuous helical fluting and sharp cutting edges. Conventional fluted instruments 80 also suffer from an occasional tendency to bind and/or to advance unpredictably into the root canal 56 by virtue of a “screwing-in” effect as the instrument is rotated. In many cases, this binding or screwing-in effect can result in the file breaking inside the canal. In the most severe cases, the fluted instrument 80 can actually drive itself through the terminus of the canal 56 and into the patient's jaw bone and surrounding soft tissues.

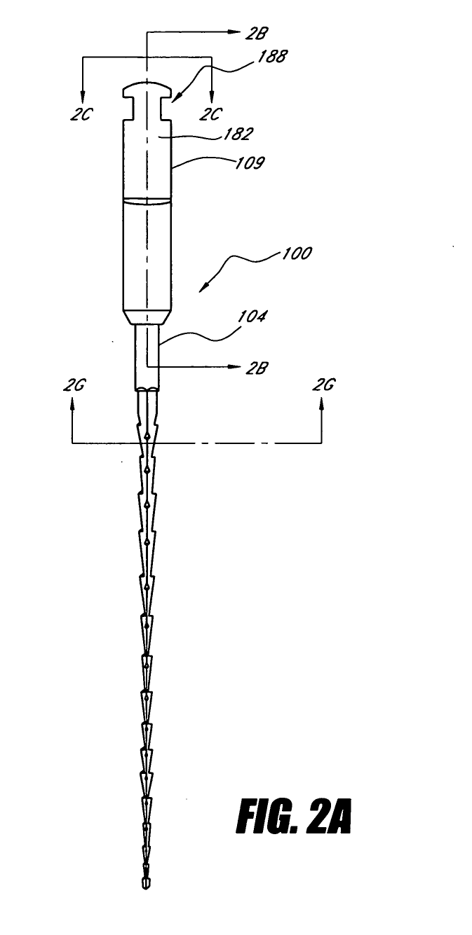

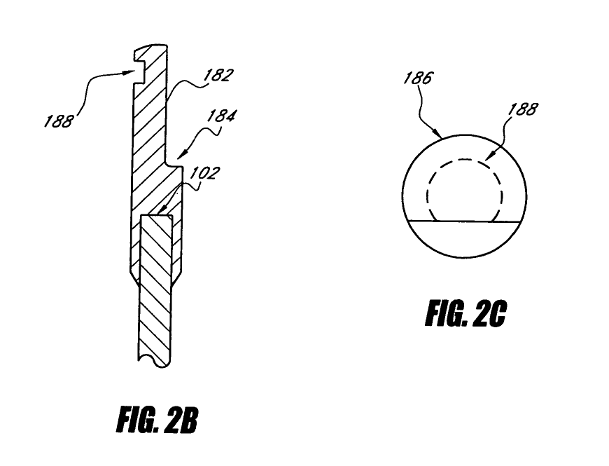

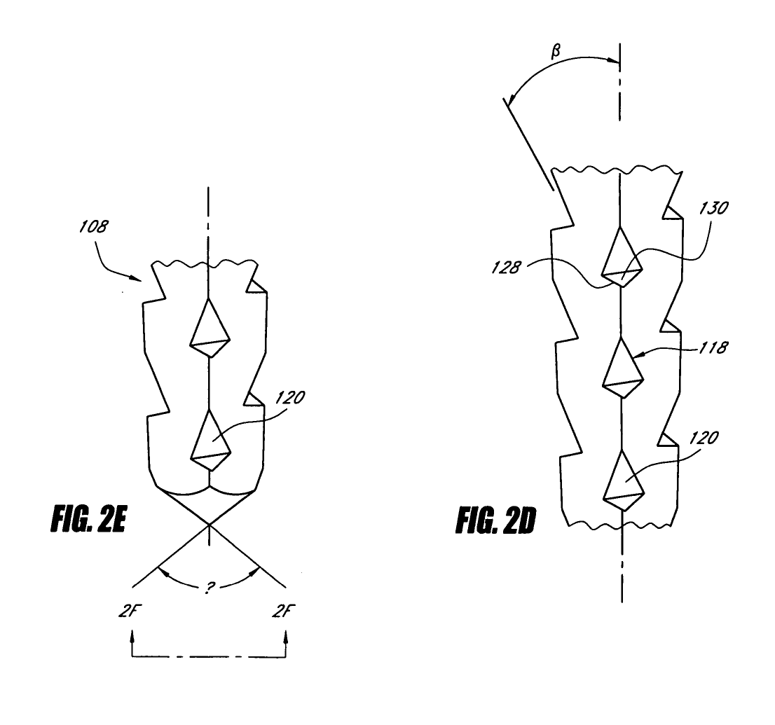

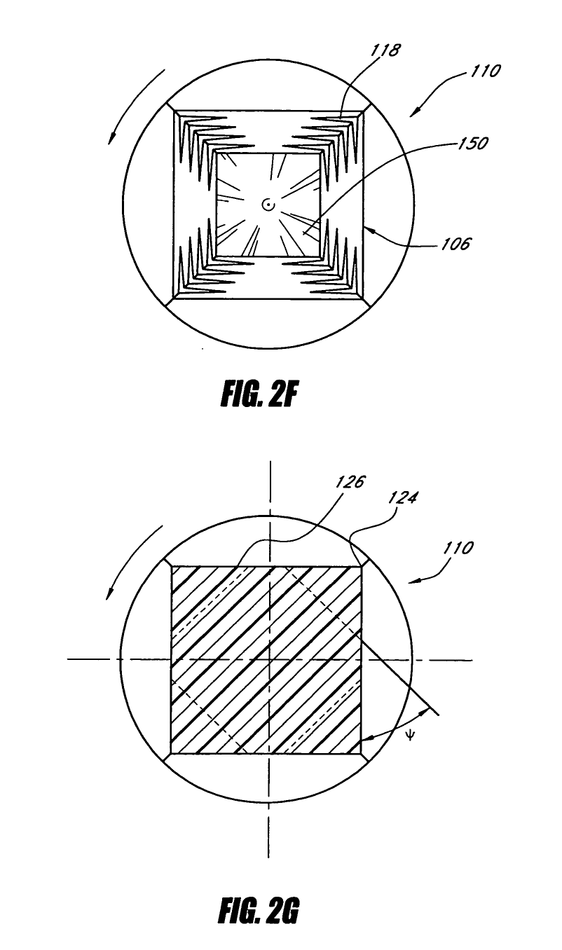

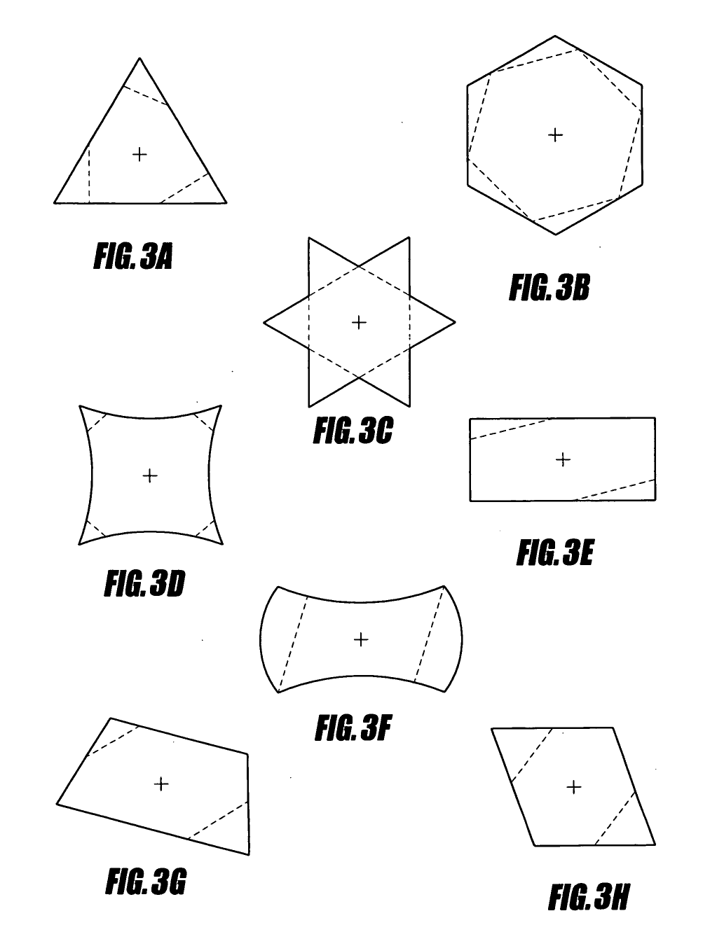

FIGS. 2A-G illustrate one embodiment of a fluteless endodontic instrument. The illustrated instrument 100 is a file that generally comprises a shank 110 having a shank portion 104 and an elongated working portion 106. The working portion 106 extends from a proximal end 107 adjacent the base of the shank 104 to a distal end 108 terminating in a tip 150. The shank portion 104 preferably includes a fitting portion 109 for mating with the chuck of a dental handpiece (not shown). As shown in FIG. 2B, the fitting portion 109 includes a generally I-shaped flat side 182 which defines a step 184 and a generally semicircular disk 186 above and adjacent to a groove 188. The groove 188 can be generally semi-circular, U-shaped, V-shaped, and/or other suitable cross section suitable for engaging a dental device. Such fitting 109 is typical of those employed in the dental industry for connecting or interfacing a dental tool with dental drill or handpiece.

Alternatively and/or in addition to the fitting portion 109, the shank portion 104 may include a knurled or otherwise treated surface (not shown) or handle to facilitate hand manipulation of the file 100. Thus, the instrument 100 may either be used by manipulating the instrument manually in a rotating or reciprocating action, or the instrument may be manipulated by attaching the fitting portion 109 of the instrument to a motorized handpiece for effecting more rapid removal of tissue from the root canal, as desired.

With reference again to FIG. 2A, the working portion 106 of the instrument 100 preferably has a length ranging from about 3 mm to about 18 mm. A standard length is about 16 mm. The working portion 106 may have a constant cross-sectional diameter or, more preferably, it is tapered from the proximal end 107 to the distal end 108, as shown. In the particular embodiment shown, the taper is substantially uniform—that is, the rate of taper is constant along the working portion 106. A preferred taper rate ranges from about 0.01 mm/mm to about 0.12 mm/mm and may be constant or varied along the length of the working portion 106. Optionally, one or more portions of the working portion 106 can be tapered and one or more portions of the working portion 106 can be substantially non-tapered. In view of the present disclosure, a skilled artisan can select the design and configuration of the working portion 106 based on the end use of the instrument 100.

The shank 110 is preferably formed from a rod of nickel titanium alloy, such as SE508 nickel-titanium wire manufactured by Nitinol Devices and Components, Inc. of Fremont, Calif. This is a typical binary nickel-titanium alloy used for endodontic files and comprises about 56% nickel and about 44% titanium by weight. Table 1, below, summarizes certain selected material properties of the SE508 NiTi alloy:

TABLE 1
SE508 MATERIAL PROPERTIES PHYSICAL PROPERTIES
PHYSICAL PROPERTIES

| | |
|---|---|
| Melting Pont | 1310° C. |
| Density | 6.5 g/cm³ |
| Electrical Resistivity | 82 μohm-cm |
| Modulus of Elasticity | 75 × 10\hat{ }6 MPa |
| Coefficient of Thermal Expansion | 11 × 10⁻⁶/° C. |

MECHANICAL PROPERTIES

| | |
|---|---|
| Ultimate Tensile Strength (UTS) | 1150 MPa |
| Total Elongation | 10% |

SUPERELASTIC PROPERTIES

| | |
|---|---|
| Loading Plateau Stress @ 3% strain | 450 MPa |
| Superelastic Strain (max) | 8% |
| Permanent Set (after 6% strain) | 0.2% |
| Transformation Temperature (AF) | 5-18° C. |

COMPOSITION

| | |
|---|---|
| Nickel (nominal) | 55.8 wt. % |
| Titanium (nominal) | 44.2 wt. % |
| Oxygen (max) | 0.05 wt. % (max) |
| Carbon (max) | 0.02 wt. % (max) |

If desired, special heat treatment(s) may be employed and/or trace elements of oxygen (O), nitrogen (N), iron (Fe), aluminum (Al), chromium (Cr), cobalt (Co) vanadium (V), zirconium (Zr) and/or copper (Cu), may be added to achieve desired mechanical properties. See, for example, U.S. Pat. No. 5,843,244 to Pelton, incorporated herein by reference. While nickel-titanium alloys are preferred, the invention disclosed herein is not limited as such, but may be practiced using a wide variety of other suitable alloys, including other super-elastic alloys and conventional medical-grade stainless steel and/or nickel alloys.

The shaft 110 is preferably rolled, ground, extruded, and/or otherwise machined to produce an elongated prismatic structure having a substantially constant and/or tapering geometric shape in cross-section. A square cross-section is particularly preferred, having four flat facing surfaces (“flats”) 126 and four corners 124 (preferably sharp), as illustrated in FIG. 2G. Of course, those skilled in the art will readily appreciate that a wide variety of other shapes may also be used with efficacy, such as triangular, hexagonal, octagonal, rectangular, or other regular polygon. Certain irregular polygons may also be used with efficacy such as those formed with one or more exposed corners and one or more facing surfaces (flat or otherwise). The polygons can have sharp or somewhat rounded edges/corners. Also, the shape can vary and/or alternate along the length of the instrument, as desired.

As shown in FIGS. 2D and 2F, a plurality of notches 118 are formed along one or more corners 124 of the shaft 110 defining cutting planes 130, cutting edges 128 and relief surfaces 120. In the illustrated embodiment, each of the corners 124 comprises a plurality of notches 118 spaced from one another. The notches 118 are preferably vertically aligned and formed in a regular spaced pattern 124 along each corner 124. Preferably, notches 118 are registered relative to notches formed on adjacent corners such that as the instrument 100 is rotated clockwise each successive corner 124 presents a notch 118 and a cutting edge 128 that is successively higher, and higher up the working portion 106 of the shank 104 from distal end 108 to the proximal end 107. Advantageously, in this manner the cutting edges 128 cut or abrade against the root canal wall, expanding the canal opening while successively urging removed and dislodged tissues upward out of the canal. Of course, those skilled in the art will readily appreciate that various alternative notch patterns may be employed, including forming notches 118 on alternating and/or selected corners 124 only, forming notches 118 in a regular or irregular spaced pattern on one or more selected corners 124, alternating the size, spacing, angle and placement of notches 118 on selected corners 124 to achieve any number of desired effects. Notches 118 may be substantially uniform in depth or, more preferably, notches 118 increase in depth from the distal end 108 to the proximal end 107 to provide optimal cutting and tissue removal as well as instrument flexibility.

If desired, notches 118 may be angled or otherwise formed to provide cutting edges 128 with a desired rake angle. Thus, preferably the cutting planes 130 are formed at an angle α with respect to the longitudinal axis 131 of the tool 100 of between about 60 degrees and 120 degrees, more preferably between about 95 degrees and 115 degrees and most preferably about 105 degrees. In an alternative embodiment, the cutting planes 130 may be formed at an angle α with respect to the longitudinal axis 131 of between about 90 degrees and 170 degrees, more preferably between about 110 degrees and 160 degrees and most preferably about 120 degrees. The relief surfaces 120 are preferably formed at an angle θ with respect to the longitudinal axis 131 of between about 5 degrees and 45 degrees, more preferably between about 10 degrees and 20 degrees and most preferably about 15 degrees. The relief surfaces 120 may also be formed at any desired angle ψ with respect to an adjacent flat surface 126. An angle ψ of about 45 degrees is chosen in the preferred embodiment illustrated in FIG. 2G. Of course, those skilled in the art will appreciate how the particular notch geometries can be varied to produce modified embodiments.

The tip 150 of the instrument 100 may assume any number of a variety of possible configurations (e.g., chisel, cone, bullet, multi-faceted and/or the like), depending upon the preference of the endodontist and manufacturing conveniences. In the illustrated embodiment, the tip 150 is formed as a simple cone, as illustrated in FIGS. 2E and 2F. The conical tip 150 preferably has an included cone angle γ of between about 45 degrees and 120 degrees, more preferably between about 60 degrees and 100 degrees and most preferably about 75 degrees. The surface of the tip 150 may be uninterrupted and/or one or more notches 118 may extend into the tip 150 to form one or more additional cutting edges, as desired. Again, those skilled in the art will readily appreciate how the particular geometries can be varied to create modified embodiments.

FIGS. 3A-H are schematic views of various alternative embodiments of fluteless endodontic instruments. FIG. 3A is a simplified schematic cross-section representation of a fluteless endodontic file having a symmetrical triangular cross-section with notches (hidden lines) and resulting cutting surfaces formed along the three exposed corners thereof. FIG. 3B is a simplified schematic cross-section representation of a fluteless endodontic file having a symmetrical hexagonal cross-section with notches (hidden lines) and resulting cutting surfaces formed along the six exposed corners thereof. FIG. 3C is a simplified schematic cross-section representation of a fluteless endodontic file having a symmetrical “star-shaped” cross-section with notches (hidden lines) and resulting cutting surfaces formed along the six exposed corners thereof. FIG. 3D is a simplified schematic cross-section representation of a fluteless endodontic file having a symmetrical square cross-section with concave flats and acute corners and with notches (hidden lines) and resulting cutting surfaces formed along the four exposed corners thereof. FIG. 3E is a simplified schematic cross-section representation of a fluteless endodontic file having a rectangular cross-section with notches (hidden lines) and resulting cutting surfaces formed along two of the exposed corners thereof. FIG. 3F is a simplified schematic cross-section representation of a fluteless endodontic file having a frusto-cylindrical cross-section with concave and convex side surfaces defining four corners and notches (hidden lines) and resulting cutting surfaces formed along two of the exposed corners thereof. FIG. 3G is a simplified schematic cross-section representation of a fluteless endodontic file having an asymmetrical polygonal cross-section with notches (hidden lines) and resulting cutting surfaces formed along two of the exposed corners thereof. FIG. 3H is a simplified schematic cross-section representation of a fluteless endodontic file having a diamond-shaped cross-section with notches (hidden lines) and resulting cutting surfaces formed along the two outer-most exposed corners thereof.

Advantageously, the fluteless file 100 according to the embodiment described above is highly efficacious in cleaning and expanding root canal openings. The notches 118 and cutting surfaces 130 formed thereby are more effective in scraping away and removing hard and soft tissues from the root canal. The notched design also reduces friction and improves the flexibility of the file for a given material and cross-section, allowing larger diameter files to be used in highly curved root canals. This improves the speed and efficacy of the root canal procedure and reduces the number of endodontic files and other specialized tools required to complete each procedure. As explained in more detail below, the disclosed file design can also be significantly less expensive to manufacture than conventional fluted files due to its relatively simple design and, most notably, the lack of helical flutes. The fluteless endodontic file design according to the above-described embodiment can be easily and expeditiously fabricated from stainless steel, nickel-titanium alloys, and/or other materials suitable for forming the file 100.

The notches 118 can be conveniently formed in the file 100. The notches 118 can be formed by a machining process, such as a grinding process. Because comparatively little material need be removed in grinding the file 100 from a tapered square or other prismatically-shaped blank, the overall grinding operation is significantly streamlined and requires less redressing and replacing of worn grinding wheels. The lack of helical flutes also diminishes the possibility of canal transportation and eliminates the possibility of the file 100 advancing unpredictably into the root canal by virtue of a “screwing in” effect. If the tip 108 were to bind or lodge in the canal, the working portion 106 of the file 100 could twist, effectively forming a reverse helix and thereby urging the file out of the canal. Thus, the overall safety of the root canal procedure is improved.

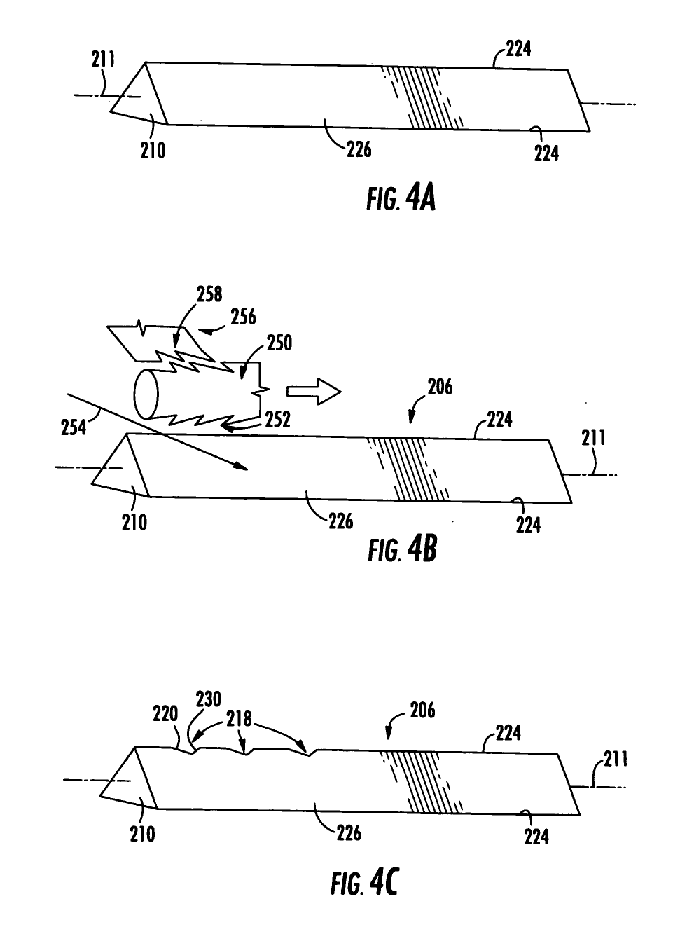

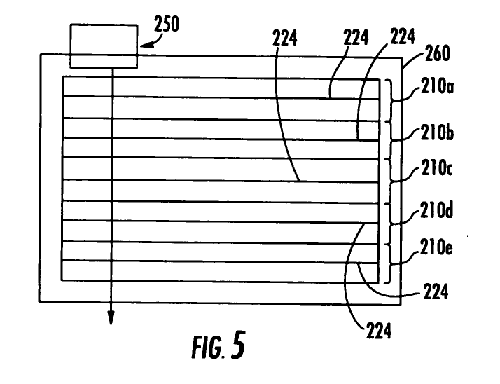

FIGS. 4A-C are time-sequenced schematic views illustrating one preferred method of manufacturing an endodontic instrument having features and advantages of the present invention. FIG. 4A shows a tapered blank shaft 210 having a desired, generally prismatic shape--in this case a triangle having three flats 226 and an equal number of interposed corners 224. The shaft 210 preferably comprises a stainless steel or Nickel-Titanium alloy, although other materials can be employed. The shaft 210 can be shaped from a length of wire by rolling, extruding, grinding, and/or other machining operations to produce the desired shape. In some embodiments, machining operations reduce the cross-section and produce the desired tapered, generally prismatic shape of the shaft 210. If sharp edges are desired at corners 224, then a final grinding operation is preferably performed to achieve a smooth ground surface on each flat 226. Of course, those skilled in the art will readily appreciate that “flats” 226 may not necessarily be flat, but may have a rounded, curved, convex and/or concave features, as may be desired. However flat surfaces are particular preferred for manufacturing expedience. In addition, those of skill in the art will recognize that the method described herein can be extended to other shapes with different numbers of sides and/or corners or none at all. For example, it is anticipated that the method and apparatus described herein can be applied to a shaft with rounded corners and/or a rounded shaft. In such an embodiment, the notches are formed on the rounded sides of the shaft.

Once the blank shaft 210 is suitably shaped, successive grinding operations are preferably carried out using a machining device, such as a rotating grinding wheel or grinding wheel assembly 250 to form a plurality of substantially vertically-aligned notches 218 on one or more corners 224, as illustrated in FIG. 4C. As shown in FIG. 4B, in a preferred embodiment the grinding wheel 250 includes at least two and preferably more than two cutting or grinding implements, which in the illustrated embodiment are in the form of a grinding notch or edge 252. Each grinding notch 252 has a shape corresponding to the desired shape of the notches 218 to be formed on the shaft 210.

The wheel 250 may be dressed, shaped and/or manipulated relative to the work piece in any suitable manner desired to produce corresponding ground cutting surfaces 220 and 230 on the notches 218 (see FIG. 4C). In a particularly preferred embodiment, the grinding wheel 250 is manipulated along a linear cutting path 254, which is generally traverse to the longitudinal axis 211 of the shaft 210. Preferably, the shape of the grinding notches 252 on the wheel 250 is configured to produce a desired inclination of the recessed surfaces 220, 230 of the notches 218. A dressing wheel 256 with corresponding notches 258 may be used to facilitate the grinding process.

In use, the grinding wheel 250 is moved across the shaft 210 (or vice-versa) in such a manner that a plurality of notches 218 are formed on the shaft 210 for each pass of the grinding wheel 250 across the shaft 210. This results in a significant saving of time as compared to prior art techniques in which the notches 218 are formed individually (see e.g., U.S. Patent Publication No. 2003/0077553, which is hereby incorporated by reference herein.) As mentioned above, the grinding wheel 250 includes at least two and preferably more than two notches 242. In other embodiments, the grinding wheel 250 is configured to create between about 2-4 of notches 218 on the shaft 210 per pass across the shaft 210. In one embodiment, the grinding wheel 250 has a length between a distal most and proximal most notches 252 of at least about 5 mm.

Depending upon the length of the working portion 206 of the instrument, less than 3 passes of the grinding wheel 250 across the shaft 210 are required to provide notches 218 over the length of the shaft 210. In embodiments in which more than one pass is used, each pass may have a different approach angle such that the orientation and/or shape of the notches 218 varies along the length of the instrument. After the notches are formed on one corner or round 224, the shaft 210 may be rotated and the process repeated along another corner 224 until notches 218 are formed on more than one and preferably all of the corners or rounds 224 on the shaft 210.

FIG. 5 is a top plan view of a modified embodiment of a method of manufacturing an endodontic instrument having features and advantages of the present invention. In this embodiment, a plurality of shafts 210a-e are placed next to each other on a workspace or table 260. One or a plurality of grinding wheels 250, with one or more grinding notches (not shown) as described above, are moved across the shafts 210a-e and/or the workspace 260 carrying the shafts 210a-e are moved across the grinding wheel(s) 250. In embodiments where multiple passes are required to apply notches 218 over the length of the shafts 210a-e, the workspace 260 and/or grinding wheel(s) 250 can be moved to apply notches 218 along the length corners 224. Once the lengths the shafts 210a-e are provided with notches 218, the shafts 210a-e can be rotated and the process described above repeated until at least one other and preferably all of the edges 224 are provided with notches 218. During the grinding process, the shafts 210a-e can be stationary or may be moved (e.g., rotated, axially translated, etc.) relative to the workspace. The shafts 210a-e may also be movable and/or repositionable with respect to each other to accommodate grinding wheels which are cutting notches at various approach angles in relation to the length axes of the shafts. Thus, the grinding wheel(s) 250 and/or the shaft(s) 210a-e may be moved or their positions in relation to one another changed to facilitate the desired grinding process.

The above described methods have several advantages. Most notably, the methods provide a particularly fast and cost effective method for mass producing a high quality endodontic instrument.

With respect to the embodiments described above, it should be appreciated that the grinding wheel assembly 250 can be formed from a plurality separate grinding wheels that are each provided with at least one notch or a portion thereof. In this manner, multiple notches can be formed on the shaft 210 per pass across the shaft 210. In particular, in the method described with reference to FIG. 5, it is anticipated that a grinding assembly comprising a plurality of separate grinding wheels each configured with one notch portion are passed over the shafts 210a-e. In this manner, a plurality of notches are formed in the shafts 210a-e in one pass.

The concepts and teachings of the present invention are particularly applicable to nickel-titanium alloys and endodontic instruments (files, reamers, obturators, drill bits and the like) fabricated therefrom. However, the inventions disclosed herein are not limited specifically to endodontic instruments fabricated from NiTi alloys, but may be practiced with a variety of dental instruments using any one of a number of other suitable medical-grade alloys. Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof Thus, it is intended that the scope of the present invention herein disclosed should not be limited by the particular disclosed embodiments described above, but should be determined only by a fair reading of the claims that follow.

What is claimed is:

1. A method for fabricating an endodontic instrument for cleaning and extirpating a root canal, comprising:
selecting at least one elongated shaft;
moving a grinding assembly across the at least one elongated shaft; and
in one pass of the grinding assembly across the at least one elongated shaft, forming multiple recesses along the at least one elongated shaft, the recesses defining exposed cutting surfaces adapted to contact walls of a root canal when the instrument is rotated and/or reciprocated therein.

2. The method as in claim 1, wherein the step of forming multiple recesses along the at least one elongated shaft comprises forming recesses along interposed corners of the at least one elongated shaft.

3. The method as in claim 1, further comprising selecting a plurality of elongated shafts each having multiple side surfaces and multiple interposed corners.

4. The method as in claim 3, further comprising moving a grinding wheel comprising multiple notches across at least one of the corners of at least a portion of the plurality of elongated shafts.

5. The method as in claim 4, further comprising, forming, in one pass, multiple recesses with the grinding wheel along the corners of the plurality of elongated shafts.

6. The method as in claim 1, wherein moving the grinding assembly across the at least one elongated shaft comprises moving a grinding wheel having multiple notches.

7. The method as in claim 1, wherein moving the grinding assembly across the at least one elongated shaft comprises moving a grinding wheel having at least three notches.

8. The method of claim 1, wherein moving a grinding assembly across at least one of the elongated shafts comprises moving multiple grinding wheels.

9. The method of claim 1, further comprising axially advancing the grinding assembly with respect to the shaft and moving the grinding assembly across the at least one elongated shaft.

10. The method of claim 1, further comprising axially advancing the grinding assembly with respect to the shaft, changing the approach angle and then moving the grinding assembly across the at least one elongated shaft.

11. The method of claim 1, wherein the elongated shaft is selected or formed to have a taper along its length.

12. The method of claim 1, wherein said multiple recesses are formed with varying depths from the proximal to the distal end of said shaft.

13. The method of claim 1, wherein said cutting surfaces are formed at an angle from the centerline of said shaft of between about 110 degrees and 160 degrees.

14. An apparatus for fabricating an endodontic instrument for cleaning and extirpating a root canal, comprising:
a working space for supporting at least one elongated shaft;
a grinding instrument for forming notches on the shaft; and
means for forming multiples recesses on the shaft in a single pass across the shaft.

15. The apparatus of claim 20, wherein the grinding instrument is a rotary cutting machine which forms multiple recesses on the shaft in a single pass across the shaft.

16. An apparatus for fabricating an endodontic instrument for cleaning and extirpating a root canal, comprising a working space for supporting a plurality of elongated shafts and a grinding instrument for forming notches on each of the plurality of shafts in a single pass.

17. A method for substantially simultaneously fabricating a plurality of endodontic instruments for cleaning and extirpating a root canal, comprising:
supporting a plurality of endodontic instrument blanks in the form of elongated shafts in a jig in substantially side-by-side relation, wherein the shafts are dimensioned to be worked to form working portions along at least a portion of their lengths for cleaning and extirpating a root canal;
forming at least one recess generally across each of at least a plurality of the elongated shafts by the action of a grinding device against the surfaces of the shafts to form at least a portion of the working portion of the endodontic instruments wherein the shafts and grinding instrument are moved in relation to one another.

18. The method of claim 17, wherein at least a portion of the lengths of the shafts are separated by spacers.

19. The method of claim 17, wherein the length axes of the shafts are substantially parallel.

20. The method of claim 17, wherein the length axes of the shafts are substantially non-parallel.

21. The method of claim 17, wherein the relative movement is accomplished, at least in part, by movement of the jig in relation to the grinding device.

22. The method of claim 17, wherein the relative movement is accomplished, at least in part, by movement of the grinding device in relation to the shafts.

23. The method of claim 17, wherein the relative movement is accomplished, at least in part, by rotation of the shafts.

24. The method of claim 17, further comprising angularly varying the relative movement during formation of the at least one recess.

25. The method of claim 17, further comprising angularly varying the relative movement between formation of recesses.

26. The method of claim 17, wherein the grinding instrument is moved after making contact with a shaft to create a recess which has varying depth or angle.
